(19) United States
(12) Patent Application Publication
(10) Pub. No.: US 2026/0130563 A1
(43) Pub. Date: May 14, 2026

(54) PROCESS FOR USING A CLEANING PRODUCT

(71) Applicant: The Procter & Gamble Company, Cincinnati, OH (US)

(72) Inventors: Nayda Liz RAMOS MEDINA, Green Township, OH (US); Mark Mason HARGETT, Liberty Township, OH (US); David John HOYING, Cincinnati, OH (US); Karen Aida MARTINEZ DE LEON, Hamilton, OH (US)

(21) Appl. No.: 18/941,190

(22) Filed: Nov. 8, 2024

(51) Int. Cl. A47L 13/16; A47L 13/24

(52) U.S. Cl. CPC A47L 13/16; A47L 13/24

(57) ABSTRACT

A process for fitting a cleaning product to a mophead and mopping a floor product. The cleaning product includes a first sheet and an outer strip joined to the first sheet. The cleaning product is fitted to the mophead such that part of the outer strip is fitted around the leading face of the mophead and part of the outer strip fitted to the bottom surface of the mophead.

### FIELD OF THE INVENTION

Process for using a cleaning product for mopping a floor.

### BACKGROUND OF THE INVENTION

A variety of cleaning products that are pads for mopping a floor are available to consumers. These cleaning products are typically built from one or more layers of nonwoven fibrous webs. These layers are typically flat nonwovens that present to the surface being wiped a uniform surface having a degree of nonuniformity, or roughness, inherent to the structure of the nonwoven per se. Designers may choose the characteristics of the nonwoven based on the type of surface to be mopped and the type of detritus that is to be removed from such surface. Characteristics including, but not limited to, the constituent material of the fibers, the shape of the fibers, the denier of the fibers, and the basis weight of the nonwoven may be given consideration in designing the cleaning product.

When it comes to soiled household surfaces, the reality is that there may be a wide range of detritus that is to be removed from the surface being cleaned. Uniform nonwoven materials used in cleaning products may be tuned to most effectively remove only a subset of that range. That can lead to users of the wipes being dissatisfied with the performance of the cleaning product across a wide range of detritus.

Cleaning products are typically fabricated from a nonwoven material having a uniform surface profile. The surface profile may include structures formed by needle punching or other solid state deformation of the nonwoven, for example by providing an embossing pattern or ridges and valleys. The surface profile employed may be designed to effectively clean a certain kind of floor having a certain kind of detritus. The reality is that consumers use cleaning products on a variety of different kinds of floors and individually such surfaces may have a variety of detritus. As such, a cleaning product having a uniform surface profile may be optimally tuned for a certain type of floor and certain type of detritus, but may be less than adequate on different types of floors having multiple types of detritus.

The cleaning products are typically applied to a mophead and the user mops the floor with the bottom surface of the mophead oriented towards the floor. The broad bottom surface of the mophead distributes out pressure applied to the floor by the weight of the mop and the force applied by the user. The user of the mop often has to exert an uncomfortable amount of force to generate enough pressure between the cleaning product and the floor to dislodge and remove detritus that is attached to the floor. Some cleaning products include a scrubbing zone intended to face the floor beneath the bottom surface of the mophead. Due to the vastness of the bottom surface of the mophead, it can be difficult for users to generate enough pressure to fully obtain the benefit of the scrubbing zone.

With the above limitations in mind, there is a continuing unaddressed need for cleaning wipes that are configured to be mountable to a mophead such that users can apply a variety of pressures from the cleaning wipe to the floor.

### SUMMARY OF THE INVENTION

A cleaning product comprising: a first sheet; a second sheet joined to said first sheet, optionally wherein said second sheet is a film or nonwoven; an absorbent core between said first sheet and said second sheet, wherein said absorbent core extends along a longitudinal axis between opposing transverse edges that cross said longitudinal axis and longitudinal edges spaced apart from said longitudinal axis and extending between said transverse edges, wherein said cleaning product has a sagittal plane coincident with said longitudinal axis and orthogonal to said absorbent core; an outer strip joined to said first sheet and extending along a strip axis parallel to and offset from said longitudinal axis, wherein said outer strip has a trailing edge inboard of said strip axis and a leading edge outboard of said strip axis, wherein for a single longitudinal edge of the absorbent core, the trailing edge is nearer to the sagittal plane than the single longitudinal edge and the leading edge is further from the sagittal plane than the single longitudinal edge.

A cleaning product comprising: a first sheet having a longitudinal centerline, wherein the cleaning product has a sagittal plane coincident with the longitudinal centerline and orthogonal to the first sheet; and an outer strip joined to the first sheet and extending along a strip axis parallel to and offset from the longitudinal centerline, wherein the outer strip has a trailing edge inboard of the strip axis and a leading edge outboard of the strip axis, wherein the trailing edge is nearer to the sagittal plane than the leading edge; wherein the cleaning product comprises a fold line coincident with the outer strip, optionally wherein the outer strip comprises predetermined weakened portions along the fold line, optionally wherein the outer strip comprises apertures, slits, slots, a crease, or combinations thereof along the fold line.

A process for fitting the cleaning product above to a mophead comprising the steps of: providing said mophead having a trailing face and leading face opposite said trailing face and a bottom surface extending from said trailing face to said leading face; and fitting said second sheet to said bottom surface such that part of said outer strip is positioned inboard of said trailing face and part of said outer strip is positioned such that said leading face is between part of said outer strip and said trailing face.

A process for mopping a floor with the cleaning product above comprising the steps of: fitting the cleaning to a mophead comprising the steps of: providing said mophead having a trailing face and leading face opposite said trailing face and a bottom surface extending from said trailing face to said leading face; and fitting said second sheet to said bottom surface such that part of said outer strip is positioned inboard of said trailing face and part of said outer strip is positioned such that said leading face is between part of said outer strip and said trailing face; mopping said floor with said bottom surface oriented towards said floor with part of said outer strip that is positioned inboard of said trailing face; and rotating said mophead to orient said leading face towards said floor and mopping said floor with part of said outer strip that is positioned such that said leading face is between part of said outer strip and said trailing face.

### BRIEF DESCRIPTION OF THE DRAWINGS

FIG. 1 is a partial view of a cleaning product.

FIG. 2 is an outer strip.

FIG. 3 is a cleaning product having a fold line.

FIG. 4 is a cleaning product folded about a fold line.

FIG. 5 is a cleaning product devoid of an absorbent core and having a fold line.

FIG. 6 is a cross section of an outer strip.

FIG. 7 is an outer strip.

FIG. 8 is a side view of part of an outer strip.

FIG. 9 is a side view of a portion of an outer strip having a coarse fiber layer overlying a fine fiber layer.

FIG. 10 is a mophead and mop handle.

FIG. 11 is a side view of a cleaning product mounted to a mophead and associated mop handle.

### DETAILED DESCRIPTION OF THE INVENTION

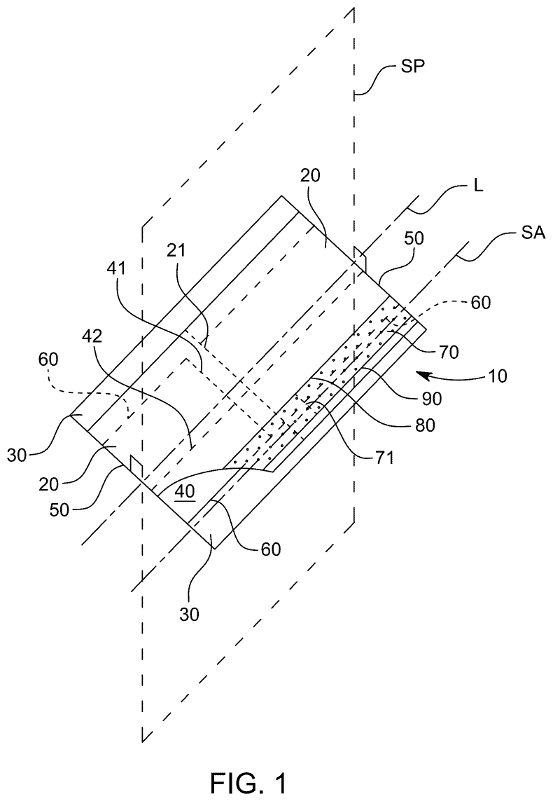

A cleaning product 10 having a diversity in its surface profile that is practical for mopping a wide variety of floors and having a wide variety of detritus disposed thereon is disclosed herein (FIG. 1). The cleaning product 10 can comprise a first sheet 20, a second sheet 30, and an absorbent core 40 between the first sheet 20 and the second sheet 30. The absorbent core 40 can extend along a longitudinal axis L between opposing transverse edges 50 that cross the longitudinal axis L. Further, the absorbent core 40 can extend between longitudinal edges 60 that are spaced apart from the longitudinal axis L and extend between the transverse edges 50. The first sheet 20 can be joined to the second sheet 30. For example, the first sheet 20 can be bonded to the second sheet 30, by way of nonlimiting example point bonded, thermal bonded, fusion bonded, adhesive bonded, or otherwise. Together, the first sheet 20 and the second sheet 30 can form a pocket housing the absorbent core 40. The bonding can be around the periphery of the first sheet 20 to bond the first sheet 20 to the second sheet 30. Optionally the bonding can be through the absorbent core 40. For further consideration of the layout of the cleaning product, it can be convenient to conceptualize the cleaning product 10 as having a sagittal plane SP coincident with the longitudinal axis L and orthogonal to the absorbent core 40.

The cleaning product 10 can further comprise an outer strip 70 joined to the first sheet 20 and extending along a strip axis SA parallel to and offset from the longitudinal axis L. The outer strip 70 can have a trailing edge 80 inboard of the strip axis SA and a leading edge 90 outboard of the strip axis SA. The trailing edge 80 is nearer to the sagittal plane SP than the leading edge 90. Likewise, the leading edge 90 can be further away from the sagittal plane SP than the trailing edge 80. As such, the trailing edge 80 is nearer to the sagittal plane SP and the leading edge 90 is further from the sagittal plane SP than one, i.e. a single or individual, longitudinal edge 60. With respect to distance from the sagittal plane SP, one longitudinal edge 60 can be between the trailing edge 80 and the leading edge 90. That is, for a single longitudinal edge 60 of the absorbent core 40, the trailing edge 80 is nearer to the sagittal plane SP than the single longitudinal edge 60 and the leading edge 90 is further from the sagittal plane SP than the single longitudinal edge 60. The trailing edge 80 can be thought of as being inboard of the strip axis SA relative to the sagittal plane SP. Likewise, the leading edge 90 can be thought of as being outboard of the strip axis SA. From the viewpoint of a top plan view of the cleaning product, the strip axis SA is between the trailing edge 80 and the leading edge 90. By positioning the outer strip 70 such that the outer strip 70 overlies or bridges over a longitudinal edge 60, the longitudinal edge 60 of the core can provide for a local stress concentration transmitted through the outer strip 70 to the floor to enhance the ability to dislodge detritus adhered to the floor.

The outer strip 70 can extend from one transverse edge 50 to the other transverse edge 50. The outer strip 70 can be continuous along the strip axis SA. The outer strip 70 can be discontinuous along the strip axis. The outer strip 70 can be inboard of the transverse edges 50. The outer strip 70 can extend from about 50% to about 100%, optionally from about 70% to about 100%, optionally from about 80% to about 100%, optionally about 100%, of the average length 42 of the absorbent core 40.

The absorbent core 40 can have an average core width 41 measured between the longitudinal edges 60 and orthogonal to the longitudinal axis L that is from about 80 mm to about 115 mm, optionally from about 80 mm to about 105 mm, optionally from about 95 mm to about 105 mm, optionally about 98 mm. The absorbent core 40 can have an average core length measured between the transverse edges 50 parallel to the longitudinal axis L that is from about 200 mm to about 450 mm, optionally from about 200 mm to about 300 mm, optionally from about 200 mm to about 270 mm, optionally about 258 mm, optionally about 430 mm. For a rectangular absorbent core 40, only a single measurement of core width is needed to characterize the average core width and only a single measurement of the core length is needed to characterize the average core length. The absorbent core 40 can have an average core length that is from about 2.2 times to about 5.0, optionally from about 2.4 times to about 3.7 times, optionally about 2.9, optionally about 4.8, times the average core width.

For an absorbent core 40 that does not have straight longitudinal edges 60 the average width between the longitudinal edges 60 measured orthogonally across the longitudinal axis L is used to compute the average core width. For an absorbent core 40 that does not have straight transverse edges 50 the average length 42 between the transverse edges 50 measured parallel to the longitudinal axis L is used to compute the average core length.

The outer strip 70 can have an average outer strip 71 width measured between the trailing edge 80 and the leading edge 90 orthogonal to the strip axis SA that is from about 10 mm to about 69 mm, optionally from about 16 mm to about 69 mm, optionally from about 16 mm to about 63 mm, optionally from about 19 mm to about 63 mm, optionally from about 20 mm to about 51 mm, optionally about 34 mm. The average outer strip width can be from about 10% to about 60%, optionally about 20% to about 60%, optionally from about 25% to about 45%, optionally about 35%, of the average core width. For a rectangular outer strip 70, only a single measurement of the outer strip width is needed to characterize the average outer strip width. For an outer strip 70 that does not have a straight trailing 80 and or leading edge 90, the average width between the trailing edge 80 and the leading edge 90 measured orthogonally across the strip axis SA is used to compute the average outer strip width.

The trailing edge 80 of the outer strip 70 can be from about 20% to about 45%, optionally from about 30% to about 35%, optionally about 33%, of the average core width away from the sagittal plane SP. The trailing edge 80 of the outer strip 70 can be from about 20 mm to about 44 mm, optionally about 29 mm to about 34 mm, optionally about 32 mm, optionally about 16 mm to about 52 mm, optionally about 24 mm to about 40 mm, optionally about 16 mm to about 47 mm, optionally about 24 mm to about 37 mm, optionally from about 19 mm to about 47 mm, optionally from about 29 mm to about 37 mm, optionally about 33 mm, away from the sagittal plane SP.

The leading edge 90 of the outer strip 70 can be from about 55% to about 80%, optionally from about 60% to about 75%, optionally from about 65% to about 70%, optionally about 67%, of said average core width away from said sagittal plane SP. The leading edge 90 of the outer strip 70 can be from about 44 mm to about 92 mm, optionally from about 48 mm to about 86 mm, optionally from about 52 mm to about 81 mm, optionally from about 44 mm to about 84 mm, optionally from about 48 mm to about 79 mm, optionally from about 52 mm to about 74 mm, optionally from about 52 mm to about 84 mm, optionally from about 57 mm to about 79 mm, optionally from about 62 mm to about 74 mm, optionally about 66 mm, away from the sagittal plane SP.

Depending on the average core width of the absorbent core 40 employed in the cleaning product, the trailing edge 80 and the leading edge 90 can be positioned such that outer strip overlies or bridges over a longitudinal edge 60. The longitudinal edge 60 of the core can provide for a local stress concentration transmitted through the outer strip 70 to the floor to enhance the ability to dislodge detritus adhered to the floor.

The first sheet 20 can have an average first sheet 21 width measured orthogonal to the sagittal plane SP. The average first sheet width can be from about 1.1 to about 2.3 times, optionally from about 1.25 to about 2.15 times, optionally from about 1.2 to about 1.3 times, optionally from about 2.0 to about 2.3 times, the average core width. The first floor sheet 20 can have an average first sheet width from about 108 mm to about 230 mm, optionally from about 123 mm to about 210 mm, optionally from about 118 mm to about 127 mm, optionally from about 196 mm to about 225 mm, optionally about 123 mm, optionally about 210 mm.

The second sheet 30 can have an average second sheet width measured orthogonal to the sagittal plane. The average first sheet width can be from about 0.5 to about 1.8 times, optionally from about 0.5 to about 0.6, optionally from about 1.6 to 1.8, optionally about 0.6, optionally about 1.7, times the average second sheet width. The second sheet 30 can have an average second sheet width from about from about 108 mm to about 230 mm, optionally from about 123 mm to about 210 mm, optionally from about 118 mm to about 127 mm, optionally from about 196 mm to about 225 mm, optionally about 123 mm, optionally about 210 mm.

The average first sheet width can be less than the average second sheet width. Optionally the average first sheet width can be greater than the average second sheet width. Optionally, the average first sheet width can be approximately the same or the same as the average second sheet width. Providing a difference between the average first sheet width and the average second sheet width can help to economize construction of the cleaning product since two webs having the full width of the cleaning product 10 or a single web that is twice the full width of the cleaning product is not needed. Using the same average first sheet width and average second sheet width can provide for increased rigidity of the cleaning product 10 outboard of the longitudinal edges 60 absorbent core 40 since two laminated webs have a greater bending stiffness than a single web. Each of the average first sheet width and the average second sheet width can be greater than the average core width. In that manner, the absorbent core can be sandwiched between the first sheet 20 and the second sheet 30.

For a rectangular first sheet 20 or second sheet 30, only a single measurement of the first sheet width or second sheet width is needed to characterize the average first sheet width or average second sheet width, width being taken across the longitudinal axis L. For a first sheet 20 or second sheet 30 that does not have straight edges generally running in the direction along the longitudinal axis L, the average width between the edges generally running in the direction along the longitudinal axis L measured orthogonally across the longitudinal axis L is used to compute the average first sheet width and the average second sheet width.

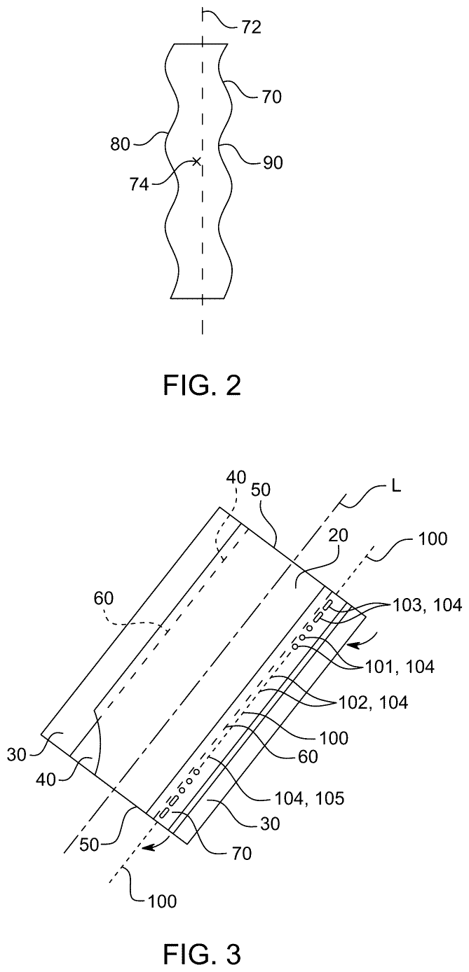

The outer strip 70 can have a line of equal weight symmetry 72 (FIG. 2). The line of equal weight symmetry 72 is a line that divides the outer strip 70 into equal weight sides. The line of equal weight symmetry 72 can be aligned with the longitudinal edge 60. Such an arrangement can effectively provide for an equal mass or area of outer strip 70 on each side of the longitudinal edge when the cleaning product is viewed in plan view. For an outer strip 70 having bilateral symmetry, the outer strip line of symmetry in a direction extending between the transverse edges can be aligned with the longitudinal edge 60. The line of equal weight symmetry 72 can be coincident with the strip axis SA. Similarly, the outer strip 70 can have a centroid 74 and the centroid 74 can be aligned with longitudinal edge 60. The aforesaid arrangements can provide for sufficient areas of the outer strip 70 to be on each side of the longitudinal edge 60 to provide for effective scrubbing and applied stress concentration from the absorbent core 40.

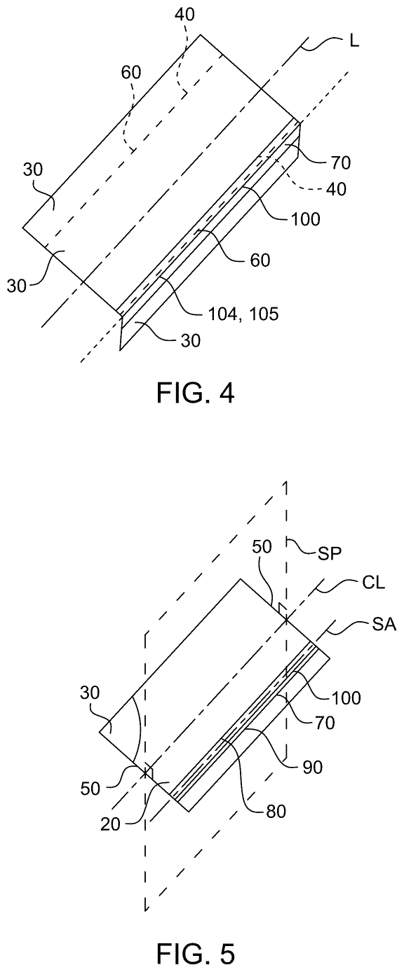

To provide for enhance transmission of stress concentration from the absorbent core 40 to the outer strip 70, it can be practical for the cleaning product 10 to comprise a fold line 100 coincident with the outer strip 70 (FIGS. 3 and 4). The fold line 100 is a line about which the cleaning product 10 has a reduced bending stiffness along an axis substantially parallel or parallel to the one or both of the longitudinal axis L or longitudinal edge 60 as compared to portions of the cleaning product 10 at 10 mm on either side of the fold line 100 about a bending axis parallel to the fold line 100. The fold line 100 can be a locally compressed portion or weakened portion of the cleaning product 10 about which the cleaning product can be folded with a limited amount of bending resistance compared to portions of the cleaning product coincident with the absorbent core 40. The fold line 100 can be continuous or discontinuous. The outer strip 70 can comprise apertures 101, slits 102, slots 103, a crease 105, or combinations thereof, along the fold line 100. Such predetermined weakened portions 104 along the fold line 100 of the outer strip 70 can make the cleaning product easier to fold and provide for a more bendable fold line 100.

The outer strip 70 can differ in color from the first sheet 20. This can help the user of the cleaning product 10 to easily identify the side of the cleaning product 10 that is to be oriented towards the floor when he or she uses the cleaning product 10.

Optionally, the cleaning product 10 may not include an absorbent core 40. Such an arrangement is practical for reducing the number and variety of materials needed to construct the cleaning wipe 10. The first sheet 20 can have a longitudinal centerline CL (FIG. 5). The longitudinal centerline CL can extend from one transverse edge 50 to the other transverse edge 50. The outer strip 70 can be joined to the first sheet 20 and extend along the strip axis SA parallel to and offset from the longitudinal centerline CL. The cleaning product 10 may comprise a fold line 100 that is coincident with the outer strip 70, the outer strip 70 spanning between the trailing edge 80 and the leading edge 90. The fold line 100 can be parallel to the longitudinal centerline CL. The fold line 100 can help the user fit the cleaning product 10 to a device for holding the cleaning wipe. Optionally, the cleaning product 10 can comprise a second sheet 30 joined to the first sheet 20, which can provide additional bulk and storage of liquid and detritus. In absence of an absorbent core 40, the first sheet 20, second sheet 30, outer strip 70 can be as described elsewhere herein.

### First Sheet and Second Sheet

The first sheet 20 and second sheet 30 can be nonwoven substrates. The nonwovens can be spun bonded, carded, hydroentangled spun bonded, melt blown, coformed, wet laid, air laid nonwovens, or combinations thereof. The nonwovens can be microfiber nonwovens comprising microfibers, which may provide for one or more of dust, soil, or liquid acquisition. The fibers constituting the nonwoven can be natural or synthetic fibers. The fibers constituting the nonwovens can be selected from, or selected from the group of, or selected from the group consisting of cellulose, polypropylene, polyethylene, polyester, and combinations thereof. The fibers constituting the nonwovens can be natural fibers or synthetic fibers. The nonwovens can be hydrophilic nonwovens so that liquid can be acquired from the floor being cleaned. One or more of the nonwovens can comprise bicomponent fibers having a sheath of polyethylene and a core of polyester. The nonwovens described herein can be bicomponent thermoplastic synthetic fibers of an outer sheath of polyester and polyethylene core. The basis weight of each nonwoven can be from about 5 to about 500 g/m², optionally from about 10 to about 120 g/m², optionally from about 15 to about 70 g/m², optionally from about 20 to about 50 g/m². The nonwovens described herein can be mixture of hydrophilic and hydrophobic fibers, for example a mixture of cellulose fibers and polyethylene or polypropylene fibers. The nonwovens described herein, including those that include hydrophilic fibers as a fraction of the fiber makeup, can be homogeneously mixed and be made by carded thermal bonding, thru-air bonding, spun lacing, or be wet laid. The nonwovens described herein can be laminates of synthetic fibers and natural fibers, for example a cellulosic tissue sandwiched between layers of synthetic fibers. The fibers of the nonwovens described herein may be coated with wax or oil to increase the ability of such coated fibers to retain solids gathered by the fibers. The nonwovens can be an about 20 g/m² to about 70 g/m² microfiber nonwoven, optionally about 60 wt % to about 80 wt % polyethylene terephthalate and 20 wt % to about 40 wt % nylon 6. Optionally, the microfiber can be a microfiber comprising about 70 wt % polyethylene terephthalate and about 30 wt % nylon 6.

Suitable nonwovens can include a nonwoven material having a basis weight from about 20 g/m² to about 150 g/m², optionally from about 20 g/m² to about 70 g/m². The nonwoven materials can comprise a combination of pulp/tissue and spun bond polypropylene hydroentangled to the pulp in a wet laid process. Optionally, one or more of the nonwovens can comprise from about 10 g/m² to about 40 g/m² pulp/tissue and from about 10 g/m² to about 30 g/m² spun bond polypropylene hydroentangled to the pulp. The thickness of each of the nonwoven materials can be from about 300 to about 600 microns. Optionally, one or more of the nonwovens can comprise about 23 g/m² of pulp/tissue and about 17 g/m² spun bond polypropylene hydroentangled with the pulp in a wet laid process. Suitable nonwovens include 30 g/m² to 70 g/m², optionally 40 g/m², GENESIS nonwoven available from Suominen, Helsinki, Finland. The nonwoven can comprise a hydroentangled spun bond nonwoven having a basis weight from about 20 g/m² to about 80 g/m².

Suitable nonwovens can also include hydroentangled spun lace nonwovens ranging in basis weight from about 20 g/m² to about 150 g/m², optionally from about 20 g/m² to about 80 g/m². The nonwoven materials can comprise a combination of polyethylene terephthalate, natural fibers, regenerated cellulose fibers, pulp, polypropylene, polyethylene fibers that are hydroentangled. The nonwoven material can be flat or be provided with an added three-dimensional structure while being hydroentangled or after hydroentangling. One example from Spuntech Industries Inc, is a 60 g/m² flat hydroentangled nonwoven with 100% carded polyethylene terephthalate fibers. Another example is a 60 g/m² flat hydroentangled spun lace with 70% carded polyethylene terephthalate fibers and 30% carded viscose fibers. Another suitable nonwoven is a 58 g/m² material that might be flat or might be an embossed hydroentangled non-woven made from about 1.7 DTEX round polyester staple fibers round polyester staple fibers (outer layers) with a spun bond nonwoven layer in the middle of about 2.2 DTEX round polypropylene fibers. This nonwoven can have a thickness from about 1 to about 2 mm sold by Suominen of Helsinki, Finland.

The first sheet 20 and or second sheet 30 can be a spun bond nonwoven. The basis weight of the spun bond nonwoven can be from about 10 to about 150 g/m², optionally from about 15 to about 90 g/m², optionally from about 20 to about 70 g/m². The nonwoven could have mono component or bicomponent fibers. One example of could be a 25 g/m² bicomponent spun bond sourced from Fitesa Inc. consisting of fibers with a sheath to core ratio of 40% to 60% polyethylene. Another example could be a 25 g/m² bicomponent spun bond with a 40% to 60% polyester by weight with color pigment in the core. The nonwoven can comprise color inside the fiber, in the core, in the sheath or both.

The nonwoven materials can comprise a bicomponent fiber comprising 1.7 DTEX round polyester staple fiber sheath and a 2.2 DTEX round spun bond polypropylene fiber core. The nonwoven materials can have a thickness from about 0.5 mm to about 4 mm, optionally from about 1 mm to about 2 mm. Optionally the nonwoven materials can comprise 50% by weight or more polyethylene terephthalate. The nonwoven can comprise a laminate of nonwovens. For example two or more plies of nonwoven can be facingly joined together by an adhesive, mechanical bonds, and or thermal bonds.

Optionally, the nonwoven can have a plastic content from about 0 % to about 10 % by weight of the nonwoven.

Suitable nonwovens include those used in SWIFFER DUSTER, SWIFFER DUSTER HEAVY DUTY, SWIFFER POWEMOP mop pads, SWIFFER WETJET dry mop pads, SWIFFER WETJET HEAVY DUTY mop pads, SWIFFER SWEEPER WET pads, SWIFFER SWEEPER DRY pads, and SWIFFER HEAVY DUTY wet cloths, available from The Procter & Gamble Company as of or prior to the effective filing date of this patent application.

The first sheet 20 can be a nonwoven, an apertured nonwoven, an apertured film, a slit film, or a combination thereof.

The first sheet may comprise an apertured nonwoven having a basis weight of about 20 to about 80 g/m² and particularly about 28 to 60 g/m². This material may be hydrophobic and made of synthetic fibers. A suitable first sheet is a 60 g/m² polyethylene/polypropylene discrete apertured spun bond nonwoven available as SOFSPAN from Fitsea of Simpsonville, SC.

The first sheet 20 and second sheet 30 may comprise a macro-apertured thermoplastic formed film. Macro-apertures are apertures that are individually discernible when viewed by the human eye from about 45 cm. The macro-apertures may be, but not limited thereto, round, oval, pentagonal, hexagonal, octagonal, rectangular, or square. The macro-apertures may be created, for example, by thermo-mechanically perforating the laminate. A formed film is a film which is extruded onto a forming screen. For example, a thermoplastic material is extruded from a cast die or blown die into a thin film. While the film material is still in a semi-molten, malleable state a pressure is applied by differential pressure means, such as vacuum, blown air, etc. to the film material to have the film material form to a screen. Macro-apertured laminates of a thermoplastic formed film and a nonwoven layer can be made according to various methods known in the art. One particular method is described in U.S. Pat. No. 8,182,728, Cree et al.

### Absorbent Core

The absorbent core 40 can be an air laid core. The absorbent core 40 can comprise cellulose fibers. Optionally, the absorbent core 40 can comprise absorbent gelling material. The absorbent core 40 can comprise multiple plies of materials including layers of foam, wet laid cellulose fibers, air laid cellulose fibers, tissue, polypropylene spun bond nonwoven, polyester fibers, bicomponent cellulose and synthetic fibers, and the like.

The absorbent core 40 can comprise a bicomponent cellulose/synthetic air laid material. The absorbent core 40 can comprise an air laid composite that is about 85:15 cellulose:bicomponent fibrous material. The absorbent core 40 can be a mixture of cellulose fibers and synthetic fibers, with cellulose fibers constituting from about 5 wt % to about 100 wt % of the absorbent core. The absorbent core 40 can have a basis weight from about 60 g/m² to about 500 g/m², optionally from about 60 g/m² to about 200 g/m², optionally any range within the aforesaid ranges. The absorbent core 40 can be an air laid composite that is 85:15 cellulose:bicomponent fibers having a basis weight of about 180 g/m².

An absorbent core 40 can be helpful for carrying or storing liquid surface treatment composition, acquiring spent liquid surface treatment composition from the floor, as well as be helpful for acquiring and storing detritus from the floor.

### Outer Strip

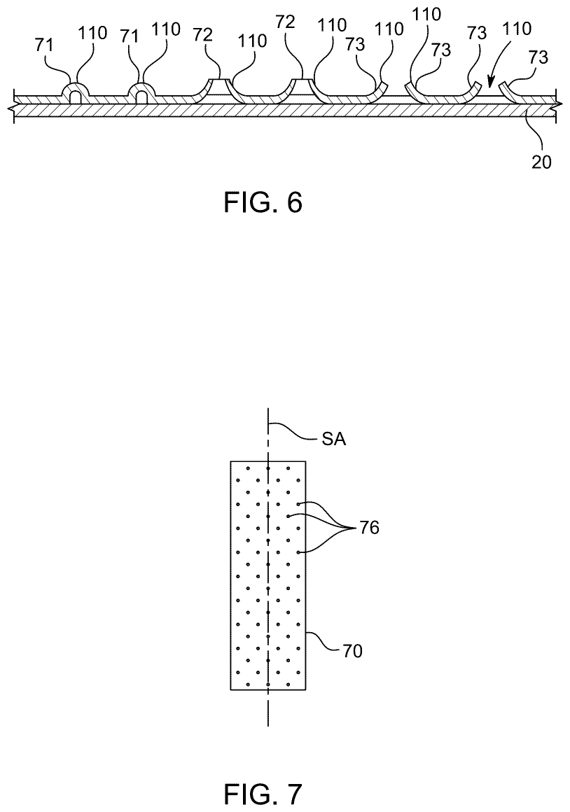

The outer strip 70 can provide for a surface that contrasts in roughness with that of the first sheet 20. The outer strip 70 can be rougher or more abrasive than the first sheet 20. Such an outer strip provides for a zone, portion, or region of the cleaning product 10 that is particularly well suited to be used for scrubbing the floor, especially portions of the floor to which detritus is affixed. The outer strip 70 can comprise a thermoplastic film having a plurality of protrusion 110 integral with and extending outwardly from film in a direction away from the first sheet 20. The thermoplastic film can be a monolayer material (FIG. 6). The protrusions of the outer strip 70 can be domes 71, cones, frustoconical, or combinations thereof. The protrusions can be frustoconical and have an open top 72. The protrusions can be flaps 73 of the outer strip 70. The outer strip 70 can be liquid pervious. The outer strip 70 can be an apertured or slit thermoplastic film. The outer strip 70 can be a polypropylene film, a high density polyethylene film, a polyester film, a nylon film, a polystyrene film, a polycarbonate film, a polyethylene terephthalate film, and film of blends and copolymers thereof. The outer strip 70 can be a multilayer structure. The film can have a thickness from about 0.02 mm to about 0.2 mm. Optionally, the film can have a flexure rigidity greater than about 0.1 g cm²/cm, as measured using a Kawabata Bending Tester Model KES-FB, available from Kato Tech Co., Ltd. The film can have a basis weight from about 10 g/m² to about 150 g/m², optionally from about 20 g/m² to about 125 g/m². By way of nonlimiting example, the outer strip 70 can be a material disclosed in U.S. Pat. No. 8,407,848 B2.

The outer strip 70 can optionally be a film nonwoven composite. For example, the outer strip 70 can be film layer overlying a nonwoven layer and discrete portions of the nonwoven layer can be protruding through openings in film layer. The protrusions of the nonwoven can be tufts of nonwoven. Such film nonwoven composites can be produced by passing the laminate through the nip of a set of counter rotating rollers. The roller contacting the nonwoven can have a plurality of discrete protrusion and the roller contacting the film can have a plurality of circumferential grooves to accommodate the discrete protrusions. In effect, the discrete protrusions punch discrete portions of the nonwoven through ruptures in the film.

The cleaning product 10 can optionally comprise a plurality of nonfibrous polymeric elements 76 that are engaged with outer strip 70 (FIG. 7). The outer strip 70 can comprise a nonwoven. The outer strip 70 can be a spun bond nonwoven, a melt blown nonwoven, or carded nonwoven.

The plurality of nonfibrous polymeric elements 76 can be engaged with the outer strip 70. The plurality of nonfibrous polymeric elements 76 can constitutively differ from the nonwoven constituting the outer strip 70. The members of the plurality of nonfibrous polymeric elements 76 can be arranged in a space centered pattern, node centered pattern, randomly, or other ordered or disordered arrangement.

The plurality of nonfibrous polymeric elements 76 can comprise a colorant, dye, or pigment to impart the desired color to the individual nonfibrous polymeric elements. For example, the outer strip 70 can be white and members of the first plurality of nonfibrous polymeric elements 76 can be blue, green, red, or other color that contrasts with the color of the outer strip 70 and or first sheet 20. The plurality of nonfibrous polymeric elements 76 and the first sheet 20 can contrast in color as observed by an observer having ordinary visual acuity in unobstructed sunlight at local noontime at a latitude between 40 degrees north and 40 degrees south. The plurality of nonfibrous polymeric elements 76 can comprise individual nonfibrous polymeric elements having colors that differ from one another or be the same color as one another.

The plurality of nonfibrous polymeric elements 76 can provide for enhanced abrasiveness, as compared to an unadulterated nonwoven that might be used for the outer strip 70. The plurality of nonfibrous polymeric elements 76 can be oriented in a direction away from the first sheet 20.

The nonfibrous polymeric elements can be ink. The ink can be a water based ink. The ink can comprise a thermoplastic material as a basis material. The ink can comprise one or more of polyacrylate, polyurethane, and polyester. Optionally, the ink can comprise a crosslinking agent. The ink optionally may include fine solid material. The ink may also comprise a colorant such as a pigment or dye to render the nonfibrous polymeric elements to be visible to a human under household lighting conditions. The polymeric elements can contrast in color with the substrate with which they are engaged. That can help the user of the cleaning products described herein recognize that the nonfibrous polymeric elements are present so that the benefit of the nonfibrous polymeric elements can be achieved by or recognized by the user of the cleaning product.

The ink can comprise an acrylic copolymer of styrene, butyl acrylate, and acrylonitrile; and an acrylic copolymer of styrene, butyl acrylate, ethyl acrylate, and acrylic acid. Optionally, the ink can further comprise one or more of a crosslinking agent, a rheology modifier, and an emulsifier. The ink can further comprise one or more of polyacrylic acid ammonium salt thickener, urea, diethylene glycol, polyethoxylated fatty alcohol, polyethoxylated isotridecanol, polyethoxylated stearyl alcohol, sodium laurel sulfate, polydimethylsiloxane, silica, oxidized aliphatic hydrocarbon, sodium benzoate, methyl isothiazolinone, methylchloroisthiazolinone, and trimethylolpropane tris-2-methyl-1-aziridinepropionate.

Optionally, the ink, as applied to the nonwoven, can be a water-based ink. The ink can optionally comprise a puffing agent. The puffing agent can be encapsulated gas, for example isobutane. The ink can be a water based ink comprising an expandable encapsulated gas, optionally configured in a manner to be a heat expandable gas. When printed the encapsulates of gas can have a diameter from about 5 mm to about 200 mm. When an ink containing a puffing agent is heated, the encapsulates expand. When the ink is dried with the puffing agent in an expanded state, the solid structure of the dried ink locks the expanded puffing agent in place, thereby forming a porous ink, also sometimes referred to as a puffed ink in the art of screen printing. When the ink constituting the plurality of nonfibrous polymeric elements 76 is puffed, the peaks of the nonfibrous elements 45 may have some jagged contours that may more abrasive than desired, particularly if any of the expandable encapsulated gas ruptures during puffing of the ink. The ink can be formulated and applied as described in U.S. Pat. No. 8,821,979 B2 and WO2004/071780 A2.

The ink can be applied to the nonwoven and then dried by heating. The resulting nonfibrous polymeric elements can have any desired shape that can be applied by screen printing or other suitable methods for printing nonwovens. The nonfibrous polymeric elements can be applied to the nonwoven by spraying, flexographic printing, screen printing, or digital printing, by way of nonlimiting example.

The nonfibrous polymeric elements, as viewed in plan view on a printed surface of the nonwoven, can be solid circles or approximate circles having a diameter from about 0.1 mm to about 3 mm. Optionally, the nonfibrous polymeric elements may protrude above the thickness of the nonwoven by 0.01 mm to about 2 mm, optionally by 0.2 mm to about 0.5 mm. The portion of individual nonfibrous polymeric elements protruding above the surface of the nonwoven may be dome shaped, for example a rounded section of a hemisphere, approximate hemisphere, oblate hemisphere, or other rounded section or partially flattened round section. The nonfibrous polymeric elements can be spaced apart from one another, optionally by a distance from about 1 mm to about 5 mm, optionally from about 1 mm to about 3 mm. Individual nonfibrous polymeric elements can have a footprint, that is a planar area or a bearing area, on or in the material with which they are engaged that is from about 0.5 mm² to about 8 mm², optionally from about 0.7 mm² to about 5 mm², optionally from about 0.7 mm² to about 3 mm². The nonfibrous polymeric elements can be discrete nonfibrous polymeric elements that are spaced apart from one another.

The nonfibrous polymeric elements can have other shapes in plan view, including but not limited to, solid or open squares, rectangles, triangles, diamonds, stars, and the like, rings, straight lines, curved lines, and compound lines, and combinations thereof. The polymeric elements can be arranged in a pattern comprising repetitive shapes or a combination of shapes. The polymeric elements can be a pattern of spaced apart solid circles. The pattern can be a space centered pattern or node centered pattern, or other repetitive arrangement or mathematically describable pattern. The nonfibrous polymeric elements can be arranged randomly. The nonfibrous polymeric elements can be spaced apart from one another. Optionally, the nonfibrous polymeric elements can be spaced apart from one another by a distance greater than the maximum dimension, optionally the maximum in plane dimension with the plane being parallel to a plane defined by the longitudinal axis and transverse axis, of the individual nonfibrous polymeric elements per se.

The solid nature of the nonfibrous polymeric elements can be more durable to compression forces than a nonwoven that is deformed to have a three dimensional surface profile. The three dimensionality of a formed nonwoven is prone to some degree of collapse, for example in use or while tightly packed in a package. The rigidity of the solid nonfibrous polymeric elements can provide for a durable three dimensional surface profile for the cleaning product that is maintained during packing, storing, and use of the cleaning product that includes the nonfibrous polymeric elements.

The plurality of nonfibrous polymeric elements 76 can have a freestanding cumulative volume beyond the outer strip 70 that is less than 0.025 mm³/mm², optionally less than 0.02 mm³/mm², optionally less than 0.015 mm³/mm², optionally less than 0.013 mm³/mm², optionally from about 0.005 mm³/mm² to about 0.025 mm³/mm², optionally from about 0.01 mm³/mm² to about 0.025 mm³/mm², optionally from about 0.01 mm³/mm² to about 0.02 mm³/mm². The freestanding cumulative volume is the cumulative volume of the plurality of nonfibrous polymeric elements 76 projecting beyond the outer strip 70 with no external loading of the plurality of nonfibrous polymeric elements 76, the plurality of nonfibrous polymeric elements 76 being an aggregate of nonfibrous polymeric elements engaged with the outer strip 70.

The outer strip 70 can comprise from about 0.5 g/m² to about 30 g/m², optionally from about 0.5 g/m² to about 20 g/m², optionally from about 1 g/m² to about 10 g/m² of said plurality of nonfibrous polymeric elements 76. At that level of application, an adequate degree of roughness can provided to the outer strip 70 to improve the efficacy of the outer strip 70 for dislodging detritus from a floor.

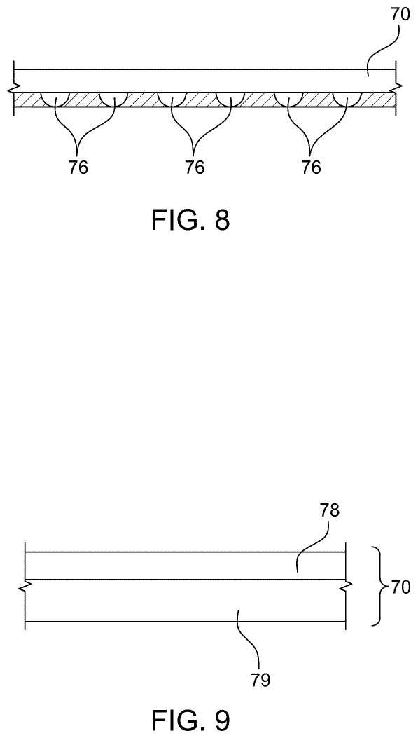

The contribution of the plurality of nonfibrous polymeric elements 76 to the bulkiness of the outer strip 70 can be characterized by the pattern created volume. The pattern created volume is the void volume between the surface of the nonwoven web and a plane P that is in contact with the top surface of the plurality of nonfibrous polymeric elements 76 at an applied pressure of 2 kPa, conceptually illustrated in FIG. 8. The pattern created volume is calculated per unit of surface area of the outer strip 70 and is represented in FIG. 8 by the shaded region. Members of the plurality of nonfibrous polymeric elements 76 can be sized and dimensioned such that the pattern created volume can be from about 0.2 mm to about 1 mm, optionally from about 0.2 mm to about 0.8 mm, optionally from about 0.3 to about 0.8 mm, optionally from about 0.4 to about 0.6 mm. Without being bound by theory, a pattern created volume greater than 1 mm may be overly abrasive for some surfaces or may limit the availability of available surface area of the outer strip 70 for acquiring detritus from the floor.

The outer strip 70 can comprise a coarse fiber layer 78 overlying and bonded to a fine fiber layer 79 (FIG. 9). The coarse fiber layer 78 can be oriented away from the absorbent core 40. The constituent fibers of the coarse fiber layer 78 can have a greater fiber diameter than constituent fibers of the fine fiber layer 79. Optionally, the constituent fibers of the coarse fiber 78 layer can have fiber diameter that is about 2 to about 1000 times greater than that of the fine fiber layer 79. Optionally, constituent fibers of the coarse fiber layer 78 have a diameter from about 10 mm to 100 mm and constituent fibers of the fine fiber layer 79 can have a diameter from about 0.1 mm to about 5 mm. Optionally, the outer strip 70 can comprise from about 20% to about 70% by weight of the outer strip 70 coarse fiber layer 78. Optionally, the outer strip 70 can comprise from about 10% to about 80% by weight of the outer strip fine fiber layer 79.

The coarse fiber layer 78 can melt blown layer. The coarse fiber layer 78 can be laid down on the fine fiber layer 79. The coarse fiber layer 78 can constitute from about 20% to about 30%, optionally from about 25% to about 30%, optionally about 26% to about 28%, by weight of the outer strip coarse fiber layer 78. The coarse fiber layer 78 can comprise coarse fibers having a diameter from about 10 mm to about 30 mm. The coarse fiber layer 78 can be formed from a polypropylene resin to which a hydrophilic melt additive is added to render the fine fiber layer hydrophilic. Optionally, a pigment can be added to the resin for color the coarse fiber layer 78.

The fine fiber layer 79 can be melt blown layer. The diameter of the fibers constituting the fine fiber layer 79 can be less than the diameter of the fibers constituting the coarse fiber layer 78. The fine fiber layer 79 can be laid down on an optional additional layer. The fine fiber layer 79 can constitute from about 10% to about 80%, optionally from about 20% to about 30%, by weight of the outer strip 70. The fine fiber layer 79 can comprise fine fibers having a diameter from about 1 mm to 10 mm. The fine fiber layer 79 can be formed from a polypropylene resin to which a hydrophilic melt additive is added to render the fine fiber layer hydrophilic. The fine fiber layer 79 can comprise fibers having a diameter of about 2 mm.

The outer strip 70 can optionally further comprise an additional fiber layer with the fine fiber layer 79 being positioned between the additional fiber layer and the coarse fiber layer 78. The additional layer can be a spun bond layer. The additional layer can constitute from about 20% to 70% by weight of the outer strip 70. The additional layer can made of coarse fibers having a diameter the same as or less than the diameter of the fibers constituting the coarse fiber layer 78. The fiber diameter of the additional layer can be greater than the fine fiber layer 78. Optionally, the additional layer can comprise fibers having a diameter of about 18 mm. The additional layer can be formed from a polypropylene resin to which a hydrophilic melt additive is added to render the produced fibers to be hydrophilic.

The layers constituting the outer strip 70 can be combined in a single calendering step. The outer strip 70 can be a material described in U.S. Pat. No. 11,148,391 B2.

### Surface Treatment Composition

The surface treatment composition can be a liquid composition that helps to clean the floor. The surface treatment composition can comprise about 99.93% by weight of the surface treatment composition water, and optionally about 0.04 % by weight of the surface treatment composition surfactant, and optionally about 0.03% by weight of the surface treatment composition perfume. Alternatively, the surface treatment composition can comprise at least about 80% by weight of the surface treatment composition water, at least 0.04% by weight of the surface treatment composition surfactant, and at least 0.03% by weight of the surface treatment composition perfume. Optionally, the surface treatment composition can comprise from about 80% to about 99.95% by weight of the surface treatment composition water, from about 0.02% to about 0.06% by weight of the surface treatment composition surfactant, and about 0.01 % to about 1 % by weight of the surface treatment composition perfume. Optionally the surface treatment composition can comprise from about 0.01% to about 4% by weight of the surface treatment composition surfactant. Optionally, the surface treatment composition can comprise from about 0.01% to about 2% by weight of the surface treatment composition surfactant. Optionally the surface treatment composition can comprise from about 0.01% to about 1% by weight of the surface treatment composition surfactant. Optionally the surface treatment composition can comprise from about 0.01% to about 0.1% by weight of the surface treatment composition surfactant. The surfactant can be a nonionic surfactant, an anionic surfactant, a cationic surfactant or a mixture thereof.

The surface treatment composition can also comprise more than about 80% by weight of the surface treatment composition water; less than 3% by weight of the surface treatment composition solvent, the solvent being selected from the group of glycol ethers, glycol phenol ethers, alcohols, mono-propylene glycol mono-propyl ether, di-propylene glycol mono-propyl ether, mono-propylene glycol mono-butyl ether, di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether and di-ethylene glycol mono-hexyl ether, and mixtures thereof. The surface treatment composition can comprise less than 1% by weight of the surface treatment composition surfactant, optionally selected from the group of nonionic surfactant, anionic surfactant, cationic surfactant, zwitterionic surfactant, and mixtures thereof; less than 1% by weight of the surface treatment composition emulsifier, for example selected from the group of ethoxylated castor oils, or hydrogenated castor oil. Additional components of the surface treatment composition can include a buffer, a preservative, a soil agglomerating polymer, a suds suppressor, an antimicrobial agents, a perfume, a thickeners, a chelant, and mixtures thereof.

### Mophead and Mop

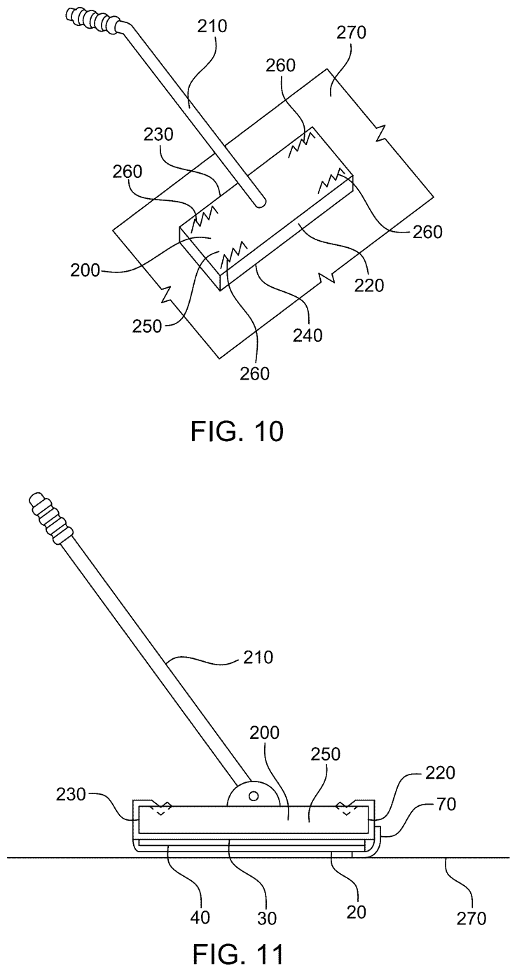

The cleaning product 10 can be used in combination with a mophead 200 (FIG. 10). The mophead 200 can be connected to a mop handle 210, which together constitute a mop. The mophead 200 can be connected to the mop handle 210 by a hinge, a ball joint, a universal joint, or other type of mechanism used for connected a mop handle 210 to a mophead 200.

The mophead 200 can have a leading face 220 and a trailing face 230 opposite the leading face. The leading face 220 can be the forward drive direction for the mop head 200 in a direction away from the user. The mophead 200 can have a bottom surface 240 extending from the leading face 220 to the trailing face 230. The bottom surface 240 is oriented towards the floor 270 to present the greatest area of the cleaning product 10 to the floor 270. The mophead 200 can have an upper surface 250 oriented in a direction opposite the bottom surface 240. The mophead 200 can comprise two or more attachment locations 260 on or built into the upper surface 250.

To install the cleaning product 10 to the mophead 200, the second sheet 30 is fitted to the bottom surface 240 of the mophead 200 such that part of the outer strip 70 is positioned inboard of the leading face 220 and part of the outer strip 70 is positioned such that the leading face 220 of the mophead 200 is between part of the outer strip 70 and the trailing face 230 of the mophead. That positions the mophead 200 and part of the outer strip 70 so that part of the absorbent core 40 is between part of the outer strip 70 and the bottom surface 240 so that part of the outer strip 70 is in contact with the floor 270 when the bottom surface 240 is oriented towards the floor 270 (FIG. 11).

To connect the cleaning product 10 to the mophead 200 the cleaning product 10 and upper surface 250 can have complementary hook and loop fasteners. Optionally the upper surface 250 can have a plurality of hooks that can mechanically engage with loops of the second sheet 30, or first sheet 20 depending on orientation and structure of the cleaning product.

When cleaning product 10 is attached to the mophead 200, the floor 270 can be mopped with the bottom surface 240 of the mophead 200 oriented towards the floor 270 with part of the outer strip 70 that is positioned inboard of the leading face 220. The mophead 200 can be rotated to orient the leading face 220 towards the floor 270 and the floor 270 can be mopped with part of the outer strip 70 that is positioned such that the leading face 220 is between part of the outer strip 70 and the trailing face 230. Since the leading face 220 has less area than the bottom surface 240, for a given load applied by the user, the stress applied to the floor is greater when the leading face 220 is presented towards the floor 270 than when the bottom surface 240 is presented towards the floor 270.

For a cleaning product 10 that includes a fold line 100 coincident with the outer strip 70, the cleaning product 10 can be fitted to the mophead 200 to align the fold line with a boundary between the leading face 220 and the bottom surface 240. The fold line 100 can help the user align the outer strip 70 to the boundary between the leading face 220 and the bottom surface 240. That can help the user of the cleaning wipe 10 properly fit the cleaning wipe 10 to the mophead 200. That can be important to make it convenient for the user to properly engage the cleaning wipe 10 with the mophead.

Within the context of this invention, providing the outer strip 70 so that the leading edge 90 and trailing edge 80 bridge over the underlying absorbent core 40 can provide the user with the ability to concentrate the stress applied to the floor 270 through the outer strip 70. The longitudinal edge 60 of the absorbent core 40 can act as a stress concentrator. The abrasiveness of the outer strip 70 can help the user dislodge detritus from the floor 270. If the user wishes to apply even more stress to the floor 270, the user can tip the mophead 200 to present the leading face 220 towards the floor and concentrated stress can be applied from the leading face 220 through the portion of the outer strip 70 engaged therewith down to the floor 270.

### Combinations

An example is below:
A. A cleaning product (10) comprising:
   a first sheet (20);
   a second sheet (30) joined to said first sheet, optionally wherein said second sheet is a film or nonwoven;
   an absorbent core (40) between said first sheet and said second sheet, wherein said absorbent core extends along a longitudinal axis (L) between opposing transverse edges (50) that cross said longitudinal axis and longitudinal edges (60) spaced apart from said longitudinal axis and extending between said transverse edges, wherein said cleaning product has a sagittal plane coincident with said longitudinal axis and orthogonal to said absorbent core; and
   an outer strip (70) joined to said first sheet and extending along a strip axis (SA) parallel to and offset from said longitudinal axis, wherein said outer strip has a trailing edge (80) inboard of said strip axis and a leading edge (90) outboard of said strip axis, wherein for a single longitudinal edge of said absorbent core, said trailing edge is nearer to said sagittal plane than said single longitudinal edge and said leading edge is further from said sagittal plane than said single longitudinal edge.
B. The cleaning product according to Paragraph A, wherein said absorbent core has an average core width measured between said longitudinal edges and orthogonal to said longitudinal axis, wherein said trailing edge of said outer strip is from about 20% to about 45% of said average core width away from said sagittal plane.
C. The cleaning product according to Paragraph A or B, wherein said absorbent core has an average core width along said longitudinal axis measured between said longitudinal edges and orthogonal to said longitudinal axis, wherein said leading edge of said outer strip is from about 55% to about 80%, optionally from about 60% to about 75%, optionally from about 65% to about 70%, optionally about 67%, of said average core width away from said sagittal plane.
D. The cleaning product according to any of Paragraphs A to C, wherein said absorbent core has an average core width measured between said longitudinal edges and orthogonal to said longitudinal axis, wherein said outer strip has an average outer strip width measured between said trailing edge and said leading edge orthogonal to said strip axis, wherein said average outer strip width is from about 10% to about 60%, optionally from about 25% to about 45%, optionally about 35%, of said average core width.
E. The cleaning product according to any of Paragraphs A to D, wherein said outer strip comprises a thermoplastic film having a plurality of protrusions integral with and extending outwardly from said film in a direction away from said first sheet.
F. The cleaning product according to any of Paragraphs A to E, wherein said outer strip comprises a nonwoven substrate.
G. The cleaning product according to Paragraph F, wherein said cleaning product comprises a plurality of nonfibrous polymeric elements (76) that constitutively differs from said outer strip and is engaged with said outer strip.
H. The cleaning product according to Paragraph G, wherein members of said plurality of nonfibrous polymeric elements comprise a porous ink.
I. The cleaning product according to Paragraph H, wherein members of said plurality of nonfibrous polymeric elements are sized and dimensioned to provide a pattern created volume of from about 0.2 mm to about 1 mm, optionally wherein members of said plurality of nonfibrous polymeric elements are sized and dimensioned to provide a pattern created volume from about 0.2 mm to about 1 mm, optionally, wherein said nonfibrous polymeric elements provide a freestanding cumulative volume beyond said nonwoven less than 0.025 mm³/mm².
J. The cleaning product according to any of Paragraphs A to D, wherein said outer strip comprises a coarse fiber layer overlying and bonded to a fine fiber layer, wherein said coarse fiber layer is oriented away from said absorbent core, wherein constituent fibers of said coarse fiber layer have a greater fiber diameter than constituent fibers of said fine fiber layer, optionally wherein said constituent fibers of said coarse fiber layer have fiber diameter that is about 2 to about 1000 times greater than that of said fine fiber layer, optionally wherein said constituent fibers of said coarse fiber layer have a diameter from about 10 μm to 100 μm and constituent fibers of said fine fiber layer have a diameter from about 0.1 μm to about 5 μm, optionally wherein said outer strip comprises from about 20% to about 70% by weight of the outer strip said coarse fiber layer, optionally wherein said outer strip comprises from about 10% to about 80% by weight of the outer strip said fine fiber layer.
K. The cleaning product according to Paragraph J, wherein said coarse fiber layer comprises melt blown fibers.
L. The cleaning product according to Paragraph K, wherein said melt blown fibers comprise polypropylene.
M. The cleaning product according to any of Paragraphs A to L, wherein said outer strip has a centroid and said centroid is aligned with said longitudinal edge, optionally wherein said outer strip has a line of symmetry and said line of symmetry is aligned with said longitudinal edge, optionally wherein said outer strip is centered over said longitudinal edge, optionally wherein said outer strip has a line of equal weight symmetry and said line of equal weight symmetry is aligned with said longitudinal edge.
N. The cleaning product according to any of Paragraphs A to M, wherein said cleaning product further comprises a surface treatment composition comprising a surfactant carried by said absorbent core.
O. The cleaning product according to any of Paragraphs A to N, wherein said absorbent core has an average core width measured between said longitudinal edges and orthogonal to said longitudinal axis, wherein said absorbent core has an average core length measured between said transverse edges and parallel to said longitudinal axis, and wherein said average core length is from about 2.2 times to about 5.0, optionally from about 2.4 times to about 3.7 times, optionally about 2.9 time, optionally about 4.4 times, said average core width.
P. The cleaning product according to any of Paragraphs A to O, wherein said absorbent core has an average core width measured between said longitudinal edges and orthogonal to said longitudinal axis, wherein said first sheet has an average first sheet width measured orthogonal to said sagittal plane, and wherein said average first sheet width is from about 1.1 to about 2.3 times, optionally from about 1.25 to about 2.15 times, optionally from about 1.2 to about 2.3 times, optionally from about 2.0 to about 2.3 times, said average core width.
Q. The cleaning product according to any of Paragraphs A to P, wherein said first sheet has an average first sheet width measured orthogonal to said sagittal plane, wherein said second sheet has an average second sheet width measured orthogonal to said sagittal plane, wherein said average first sheet width is from about 0.5 to about 1.8, optionally from about 0.5 to about 0.6, optionally from about 1.6 to about 1.8, optionally about 0.6, optionally about 1.7, times said average second sheet width.
R. The cleaning product according to any of Paragraphs A to Q, wherein said cleaning product comprises a fold line (100) coincident with said outer strip, optionally wherein said outer strip comprises predetermined weakened portions 104 along said fold line, optionally wherein said outer strip comprises apertures 101, slits 102, slots 103, a crease 105, or combinations thereof along said fold line.
S. The cleaning product according to any of Paragraphs A to R, wherein said absorbent core has an average core width measured between said longitudinal edges and orthogonal to said longitudinal axis from about 80 mm to about 115 mm, optionally from about 80 mm to about 105 mm, optionally from about 95 mm to about 105 mm, optionally about 98 mm.
T. The cleaning product according to any of Paragraphs A to S, wherein said absorbent core has an average core length measured between said transverse edges and parallel to said longitudinal axis from about 200 mm to about 450 mm, optionally from about 200 mm to about 300 mm, optionally from about 200 mm to about 270 mm, optionally about 258 mm, optionally about 430 mm.
U. The cleaning product according to any of Paragraphs A to T, wherein said outer strip differs in color from said first sheet.
V. The cleaning product according to any of Paragraphs A to U, wherein said first sheet is a nonwoven, an apertured film, a slit film, or a combination thereof.
W. A cleaning product (10) comprising:
   a first sheet (20) having a longitudinal centerline (CL), wherein said cleaning product has a sagittal plane coincident with said longitudinal centerline and orthogonal to said first sheet; and
   an outer strip (70) joined to said first sheet (20) and extending along a strip axis (SA) parallel to and offset from said longitudinal centerline, wherein said outer strip has a trailing edge (80) inboard of said strip axis and a leading edge (90) outboard of said strip axis, wherein said trailing edge is nearer to said sagittal plane than said leading edge;
   wherein said cleaning product comprises a fold line (100) coincident with said outer strip, optionally wherein said outer strip comprises predetermined weakened portions 104 along said fold line, optionally wherein said outer strip comprises apertures 101, slits 102, slots 103, a crease 105, or combinations thereof along said fold line.
X. The cleaning product according to Paragraph W, wherein said cleaning product further comprises a second sheet (30) joined to said first sheet, optionally wherein said second sheet is a film or nonwoven
Y. The cleaning product according to Paragraph W or X, wherein said outer strip comprises a thermoplastic film having a plurality of protrusions integral with and extending outwardly from said film in a direction away from said first sheet.
Z. The cleaning product according to any of Paragraphs W to Y, wherein said outer strip comprises a nonwoven substrate.
AA. The cleaning product according to Paragraph Z, wherein said cleaning product comprises a plurality of nonfibrous polymeric elements (76) that constitutively differs from said outer strip and is engaged with said outer strip.
BB. The cleaning product according to Paragraph AA, wherein members of said plurality of nonfibrous polymeric elements comprise a porous ink.
CC. The cleaning product according to Paragraph AA, wherein members of said plurality of nonfibrous polymeric elements are sized and dimensioned to provide a pattern created volume of from about 0.2 mm to about 1 mm, optionally wherein members of said plurality of nonfibrous polymeric elements are sized and dimensioned to provide a pattern created volume from about 0.2 mm to about 1 mm, optionally, wherein said nonfibrous polymeric elements provide a freestanding cumulative volume beyond said nonwoven less than 0.025 mm³/mm².
DD. The cleaning product according to any of Paragraphs W to Z, wherein said outer strip comprises a coarse fiber layer overlying and bonded to a fine fiber layer, wherein said coarse fiber layer is oriented away from said absorbent core, wherein constituent fibers of said coarse fiber layer have a greater fiber diameter than constituent fibers of said fine fiber layer, optionally wherein said constituent fibers of said coarse fiber layer have fiber diameter that is about 2 to about 1000 times greater than that of said fine fiber layer, optionally wherein said constituent fibers of said coarse fiber layer have a diameter from about 10 mm to 100 mm and constituent fibers of said fine fiber layer have a diameter from about 0.1 mm to about 5 mm, optionally wherein said outer strip comprises from about 20% to about 70% by weight of the outer strip said coarse fiber layer, optionally wherein said outer strip comprises from about 10% to about 80% by weight of the outer strip said fine fiber layer.
EE. The cleaning product according to Paragraph DD, wherein said coarse fiber layer comprises melt blown fibers.
FF. The cleaning product according to Paragraph EE, wherein said melt blown fibers comprise polypropylene.
GG. The cleaning product according to any of Paragraphs W to FF, wherein said cleaning product further comprises a surface treatment composition comprising a surfactant carried by said first sheet.
HH. The cleaning product according to any of Paragraphs W to GG wherein said first sheet has an average first sheet width measured orthogonal to said sagittal plane, wherein said second sheet has an average second sheet width measured orthogonal to said sagittal plane, wherein said average first sheet width is from about 0.5 to about 1.8, optionally from about 0.5 to about 0.6, optionally from about 1.6 to about 1.8, optionally about 0.6, optionally about 1.7, times said average second sheet width.
II. The cleaning product according to any of Paragraphs W to HH, wherein said outer strip differs in color from said first sheet.
JJ. The cleaning product according to any of Paragraphs W to II, wherein said first sheet is a nonwoven, an apertured film, a slit film, or a combination thereof.
KK. A process for fitting the cleaning product according to any of Paragraphs A to JJ to a mophead comprising the steps of:
   providing said mophead (200) having a leading face (220) and a trailing face (230) opposite the leading face and a bottom surface (240) extending from said leading face to said trailing face; and
   fitting said second sheet to said bottom surface such that part of said outer strip is positioned inboard of said leading face and part of said outer strip is positioned such that part of said leading face is between part of said outer strip and part of said trailing face.
LL. The process according to Paragraph KK, wherein said cleaning product comprises a fold line coincident with said outer strip, and said cleaning product is fitted to said mophead to align said fold line with a boundary between said leading face and said bottom surface.
MM. A process for mopping a floor with the cleaning product according to any of Paragraphs A to JJ comprising the steps of:
   fitting the cleaning to a mophead comprising the steps of:
      providing said mophead having a trailing face and leading face opposite said trailing face and a bottom surface extending from said trailing face to said leading face; and
fitting said second sheet to said bottom surface such that part of said outer strip is positioned inboard of said leading face and part of said outer strip is positioned such that part of said leading face is between part of said outer strip and part of said trailing face;
mopping said floor with said bottom surface oriented towards said floor with part of said outer strip that is positioned inboard of said leading face; and
rotating said mophead to orient said leading face towards said floor and mopping said floor with part of said outer strip that is positioned such that part of said leading face is between part of said outer strip and part of said trailing face.
NN. The process according to Paragraph MM, wherein said cleaning product comprises a fold line coincident with said outer strip, and said cleaning product is fitted to said mophead to align said fold line with a boundary between said leading face and said bottom surface.

With respect to any ranges articulated within this patent application, whole number ranges and decimal ranges within the articulated ranges, are contemplated. For example, within a range of about 1 to about 10, the range of about 3 to about 4 is contemplated. Within a range of about 0.5 to about 3, the ranges of about 0.7 to about 1.5, about 0.75 to about 1, and about 0.55 to about 0.85 are contemplated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for fitting a cleaning product to a mophead comprising the steps of:
providing a cleaning product comprising:
a first sheet;
a second sheet joined to said first sheet;
an absorbent core between said first sheet and said second sheet, wherein said absorbent core extends along a longitudinal axis between opposing transverse edges that cross said longitudinal axis and longitudinal edges spaced apart from said longitudinal axis and extending between said transverse edges, wherein said cleaning product has a sagittal plane coincident with said longitudinal axis and orthogonal to said absorbent core; and
an outer strip joined to said first sheet and extending along a strip axis parallel to and offset from said longitudinal axis, wherein said outer strip has a trailing edge inboard of said strip axis and a leading edge outboard of said strip axis, wherein for a single longitudinal edge of said absorbent core, said trailing edge is nearer to said sagittal plane than said single longitudinal edge and said leading edge is further from said sagittal plane than said single longitudinal edge;
providing said mophead having a leading face and a trailing face opposite the leading face and a bottom surface extending from said leading face to said trailing face; and
fitting said second sheet to said bottom surface such that part of said outer strip is positioned inboard of said leading face and part of said outer strip is positioned such that part of said leading face is between part of said outer strip and part of said trailing face.

2. The process according to claim 1, wherein said cleaning product comprises a fold line coincident with said outer strip, and said cleaning product is fitted to said mophead to align said fold line with a boundary between said leading face and said bottom surface.

3. The process according to claim 1, wherein said absorbent core has an average core width measured between said longitudinal edges and orthogonal to said longitudinal axis, wherein said trailing edge of said outer strip is from about 20% to about 45% of said average core width away from said sagittal plane.

4. The process according to claim 3, wherein said absorbent core has an average core width along said longitudinal axis measured between said longitudinal edges and orthogonal to said longitudinal axis, wherein said leading edge of said outer strip is from about 55% to about 80% of said average core width away from said sagittal plane.

5. The process according to claim 4, wherein said absorbent core has an average core width measured between said longitudinal edges and orthogonal to said longitudinal axis, wherein said outer strip has an average outer strip width measured between said trailing edge and said leading edge orthogonal to said strip axis, wherein said average outer strip width is from about 10% to about 60% of said average core width.

6. The process according to claim 5, wherein said outer strip comprises a thermoplastic film having a plurality of protrusions integral with and extending outwardly from said film in a direction away from said first sheet.

7. The process according to claim 5, wherein said outer strip comprises a nonwoven substrate.

8. The process according to claim 7 wherein said cleaning product comprises a plurality of nonfibrous polymeric elements that constitutively differs from said outer strip and is engaged with said outer strip.

9. The process according to claim 8, wherein members of said plurality of nonfibrous polymeric elements comprise a porous ink.

10. The process according to claim 5, wherein members of said plurality of nonfibrous polymeric elements are sized and dimensioned to provide a pattern created volume of from about 0.2 mm to about 1 mm.

11. The process according to claim 5, wherein said outer strip comprises a coarse fiber layer overlying and bonded to a fine fiber layer, wherein said coarse fiber layer is oriented away from said absorbent core, wherein constituent fibers of said coarse fiber layer have a greater fiber diameter than constituent fibers of said fine fiber layer.

12. The process according to claim 5, wherein said cleaning product further comprises a surface treatment composition comprising a surfactant carried by said absorbent core.

13. The process according to claim 1, wherein said cleaning product comprises a fold line coincident with said outer strip, wherein said outer strip comprises predetermined weakened portions 104 along said fold line.

14. A process for mopping a floor with a cleaning product comprising the steps of:
providing a cleaning product comprising:
a first sheet;
a second sheet joined to said first sheet;
an absorbent core between said first sheet and said second sheet, wherein said absorbent core extends along a longitudinal axis between opposing transverse edges that cross said longitudinal axis and longitudinal edges spaced apart from said longitudinal axis and extending between said transverse edges, wherein said cleaning product has a sagittal plane coincident with said longitudinal axis and orthogonal to said absorbent core; and
an outer strip joined to said first sheet and extending along a strip axis parallel to and offset from said longitudinal axis, wherein said outer strip has a trailing edge inboard of said strip axis and a leading edge outboard of said strip axis, wherein for a single longitudinal edge of said absorbent core, said trailing edge is nearer to said sagittal plane than said single longitudinal edge and said leading edge is further from said sagittal plane than said single longitudinal edge;
providing a mophead having a leading face and a trailing face opposite the leading face and a bottom surface extending from said leading face to said trailing face; and fitting said second sheet to said bottom surface such that part of said outer strip is positioned inboard of said leading face and part of said outer strip is positioned such that part of said leading face is between part of said outer strip and part of said trailing face;
mopping said floor with said bottom surface oriented towards said floor with part of said outer strip that is positioned inboard of said leading face; and
rotating said mophead to orient said leading face towards said floor and mopping said floor with part of said outer strip that is positioned such that part of said leading face is between part of said outer strip and part of said trailing face.

15. The process according to claim 14, wherein said cleaning product comprises a fold line coincident with said outer strip, and said cleaning product is fitted to said mophead to align said fold line with a boundary between said leading face and said bottom surface.

16. The process according to claim 14, wherein said absorbent core has an average core width measured between said longitudinal edges and orthogonal to said longitudinal axis, wherein said trailing edge of said outer strip is from about 20% to about 45% of said average core width away from said sagittal plane.

17. The process according to claim 14, wherein said absorbent core has an average core width along said longitudinal axis measured between said longitudinal edges and orthogonal to said longitudinal axis, wherein said leading edge of said outer strip is from about 55% to about 80% of said average core width away from said sagittal plane.

18. A process for fitting a cleaning product to a mophead comprising the steps of:
providing a cleaning product comprising:
a first sheet having a longitudinal centerline, wherein said cleaning product has a sagittal plane coincident with said longitudinal centerline and orthogonal to said first sheet; and
an outer strip joined to said first sheet and extending along a strip axis parallel to and offset from said longitudinal centerline, wherein said outer strip has a trailing edge inboard of said strip axis and a leading edge outboard of said strip axis, wherein said trailing edge is nearer to said sagittal plane than said leading edge;
wherein said cleaning product comprises a fold line coincident with said outer strip;
providing said mophead having a leading face and a trailing face opposite the leading face and a bottom surface extending from said leading face to said trailing face; and
fitting said second sheet to said bottom surface such that part of said outer strip is positioned inboard of said leading face and part of said outer strip is positioned such that part of said leading face is between part of said outer strip and part of said trailing face.

19. The process according to claim 18, wherein said cleaning product further comprises a second sheet joined to said first sheet.

20. The process according to claim 18, wherein said outer strip comprises a nonwoven substrate.
